(19) United States
(12) Patent Application Publication
(10) Pub. No.: US 2024/0280511 A1
(43) Pub. Date: Aug. 22, 2024

(54) DANGEROUS ARTICLE DETECTION APPARATUS

(71) Applicant: Moon Sik SHIN, Gumi-si (KR)

(72) Inventor: Moon Sik SHIN, Gumi-si (KR)

(21) Appl. No.: 18/024,024

(22) PCT Filed: Sep. 28, 2022
(86) PCT No.: PCT/KR2022/014590

§ 371 Date: Feb. 28, 2023

(30) Foreign Application Priority Data
Sep. 27, 2022 (KR) 10-2022-0122315

(51) Int. Cl. G01N 23/04; G01V 5/22

(52) U.S. Cl. CPC G01N 23/04; G01V 5/22

(57) ABSTRACT

A dangerous article detection apparatus according to one embodiment of the present invention is related to a dangerous article detection apparatus configured to detect a dangerous article hidden by an object to be inspected by irradiating an electromagnetic wave, which is a millimeter wave or a terahertz wave, to an inspection path through which the object to be inspected moves, and including an inspection module configured to apply the electromagnetic wave to the object to be inspected moving along the inspection path, receive an electromagnetic wave reflected from the object to be inspected, and generate image data on the basis of the electromagnetic waves, and a server configured to display the dangerous article hidden by the object to be inspected on the basis of the image data received from the inspection module.

### TECHNICAL FIELD

The present invention relates to a dangerous article detection apparatus configured to detect a dangerous article hidden by an object to be inspected, and more particularly, to a dangerous article detection apparatus configured to detect a dangerous article hidden by an object to be inspected by irradiating electromagnetic waves that are millimeter waves or terahertz waves to an inspection path through which the object to be inspected moves.

### BACKGROUND ART

In airports or ports, inspections are conducted on cargo (carry-ons and consignments) and passengers to prevent items such as weapons, explosives, and narcotics included in the cargo and belongings of the passengers from being brought into or taken out of the country.

Currently, for the cargo, the approximate size, shape, and type of the target cargo are visually determined using X-ray radiography imaging technology to select an object to be inspected.

For the passengers, an inspection method using a metal detector is used.

X-ray inspection is convenient because cargo moving on a conveyor belt can be inspected without opening the contents, but, in the case of X-ray radiography images, there are cases in which images of several objects overlap, and thus, when this technique is used alone, the inspection may not be satisfactory.

In addition, when passengers are inspected with a metal detector, there is a problem in that it is difficult to search for weapons, explosives, and narcotics that are not metals and belong to non-metals.

In addition, there is a problem in that X-ray inspection, which affects human health, cannot be used to inspect passengers.

In order to solve such problems, Korean Registered Patent No. 10-1305300 B1 (registered on Sep. 2, 2013) discloses a unified inspection method and a millimeter wave inspection system for cargo and passengers, in which one from among X-ray backscatter analysis, X-ray fluorescence analysis, visual inspection, and vapor sample chemical analysis other than X-ray radiography image analysis is additionally performed for cargo inspection in addition to the X-ray radiography image analysis, and an inspection method using millimeter waves is additionally performed for passenger inspection in addition to inspection using a metal detector.

However, the millimeter wave inspection system has a problem in that millimeter waves are not efficiently collected and thus an accurate image of an object to be inspected is not secured with the millimeter waves.

### DISCLOSURE

### Technical Problem

The present invention has been proposed to resolve the above-described problems, and the present invention is directed to providing a dangerous article detection apparatus capable of providing more detailed image data on a dangerous article hidden by an object to be inspected by applying millimeter waves or terahertz waves to the object to be inspected more efficiently, and focusing millimeter waves or terahertz waves reflected by the object to be inspected more effectively.

The problem to be solved by the present invention is not limited to the above-described problem, and other objects which are not mentioned are to be understood by those skilled in the art from the present specification and the accompanying drawings.

### Technical Solution

A dangerous article detection apparatus according to one embodiment of the present invention is related to a dangerous article detection apparatus configured to detect a dangerous article hidden by an object to be inspected by irradiating an electromagnetic wave, which is a millimeter wave or a terahertz wave, to an inspection path through which the object to be inspected moves, and including an inspection module configured to apply the electromagnetic wave to the object to be inspected moving along the inspection path, receives an electromagnetic wave reflected from the object to be inspected, and generate image data on the basis of the electromagnetic waves, and a server configured to display the dangerous article hidden by the object to be inspected on the basis of the image data received from the inspection module, wherein the inspection module includes a camera unit configured to generate an image of the object to be inspected, an output unit configured to output the electromagnetic wave, a lens unit configured to focus the electromagnetic wave reflected from the object to be inspected, and an image generation unit configured to receive the electromagnetic wave focused by the lens unit and generate the image data on the basis of the electromagnetic wave.

### Advantageous Effects

According to a dangerous article detection apparatus according to one embodiment of the present invention, more detailed image data on a dangerous article hidden by an object to be inspected can be provided by applying millimeter waves or terahertz waves to the object to be inspected more efficiently, and focusing millimeter waves or terahertz waves reflected by the object to be inspected more effectively, so that an administrator can more easily detect the dangerous article.

In addition, according to a dangerous article detection apparatus according to one embodiment of the present invention, inspection can be performed more efficiently since the inspection is performed while a plurality of objects to be inspected are moving.

Effects of the present invention are not limited to the above-described effects, and effects not mentioned herein will be clearly understood by those skilled in the art from the present specification and the accompanying drawings.

### DESCRIPTION OF DRAWINGS

FIG. 1 is a schematic view for generally describing a dangerous article detection apparatus according to one embodiment of the present invention.

FIG. 2 is a set of a schematic view and a block diagram for describing an inspection module and a server constituting the dangerous article detection apparatus according to one embodiment of the present invention.

FIG. 3 is a set of a front view and a plan view for describing a state in which the dangerous article detection apparatus according to one embodiment of the present invention inspects an object to be inspected moving on an inspection path.

FIG. 4 is a set of a front view and a plan view for describing a state in which the dangerous article detection apparatus according to one embodiment of the present invention inspects the object to be inspected moving on the inspection path.

FIG. 5 is a schematic view for describing a state in which the dangerous article detection apparatus according to one embodiment of the present invention inspects a plurality of objects to be inspected moving on the inspection path.

FIG. 6 is a set of photographs obtained by testing hidden dangerous article detection by inspecting a plurality of objects to be inspected moving on an inspection path by the dangerous article detection apparatus according to one embodiment of the present invention.

FIG. 7 is a front view for describing a lens unit that is a component of the dangerous article detection apparatus according to one embodiment of the present invention.

FIG. 8 is a front view for describing the lens unit that is a component of the dangerous article detection apparatus according to one embodiment of the present invention.

### MODES OF THE INVENTION

Hereinafter, detailed embodiments of the present invention will be described in detail with reference to the drawings. However, the spirit of the present invention is not limited to the embodiments presented herein, and those skilled in the art who understand the spirit of the present invention may easily propose other regressive inventions or other embodiments included in the scope of the present invention through addition, change, deletion, and the like of other components within the same scope of the spirit. However, these embodiments are also included in the scope of the present invention.

A dangerous article detection apparatus according to one embodiment of the present invention is related to a dangerous article detection apparatus configured to detect a dangerous article hidden by an object to be inspected by irradiating an electromagnetic wave, which is a millimeter wave or a terahertz wave, to an inspection path through which the object to be inspected moves, and including an inspection module configured to apply the electromagnetic wave to the object to be inspected moving along the inspection path, receive an electromagnetic wave reflected from the object to be inspected, and generate image data on the basis of the electromagnetic waves, and a server configured to display the dangerous article hidden by the object to be inspected on the basis of the image data received from the inspection module, wherein the inspection module includes a camera unit configured to generate an image of the object to be inspected, an output unit configured to output the electromagnetic wave, a lens unit configured to focus the electromagnetic wave reflected from the object to be inspected, and an image generation unit configured to receive the electromagnetic wave focused by the lens unit and generate the image data on the basis of the electromagnetic wave.

In addition, in the dangerous article detection apparatus, the inspection module may further include a first inspection module configured to apply the electromagnetic wave to a front surface and one side surface of the object to be inspected on the inspection path, and a second inspection module configured to apply the electromagnetic wave to a rear surface and the other side surface of the object to be inspected on the inspection path, wherein the first inspection module and the second inspection module may be disposed to be spaced apart from each other by a predetermined distance in a first direction and in a second direction perpendicular to the first direction on the inspection path.

In addition, in the dangerous article detection apparatus, the server may further include a communication unit configured to receive the image data from the image generation unit, a display unit configured to output the received image data, a storage unit in which reference data, which is data corresponding to a plurality of dangerous articles, is stored, and a control unit configured to control the communication unit, the display unit, and the storage unit, wherein, when the hidden dangerous article is detected from the image data on the basis of the reference data, the control unit may control the display unit to output an icon corresponding to the hidden dangerous article from the image data, and control the communication unit to send a notification notifying that the hidden dangerous article is detected to an administrator terminal.

In addition, in the dangerous article detection apparatus, the lens unit may further include a first lens unit configured to receive the electromagnetic wave reflected from the object to be inspected and refract a portion of the electromagnetic wave at a predetermined angle, a second lens unit disposed to be spaced apart from the first lens unit by a predetermined distance in a length direction of the inspection module and configured to allow the electromagnetic wave emitted from the first lens unit to be incident and refracted at a predetermined angle, and a third lens unit that is partially in contact with the second lens unit and allows the electromagnetic wave emitted from the second lens unit to be incident and focused on the image generation unit.

In addition, in the dangerous article detection apparatus, the first lens unit may further include a first incident surface on which the electromagnetic wave reflected from the object to be inspected is incident, and a first exit surface through which the incident electromagnetic wave is emitted, wherein the first incident surface may further include a round portion having one side and the other side, each of which has a convex shape in a height direction of the inspection module perpendicular to the length direction of the inspection module, and a parallel portion extending from the round portion and parallel to the height direction, and the first exit surface may have a shape corresponding to the incident surface.

In addition, in the dangerous article detection apparatus, the first lens unit may be formed shorter than a length of the second lens unit in the height direction, and the second lens unit may further include a second incident surface on which the electromagnetic wave emitted from the first exit surface is incident, and a second exit surface through which the incident electromagnetic wave is emitted, wherein the second incident surface may have a concave shape, and the second exit surface may have a convex shape.

In addition, in the dangerous article detection apparatus, the second lens unit may be formed longer than a length of the third lens unit in the height direction, and the third lens unit may further include a third incident surface on which the electromagnetic wave emitted from the second exit surface is incident, wherein the third incident surface may have a convex shape.

Elements having the same functions within the same scope shown in the drawings of each embodiment are described using the same reference numerals.

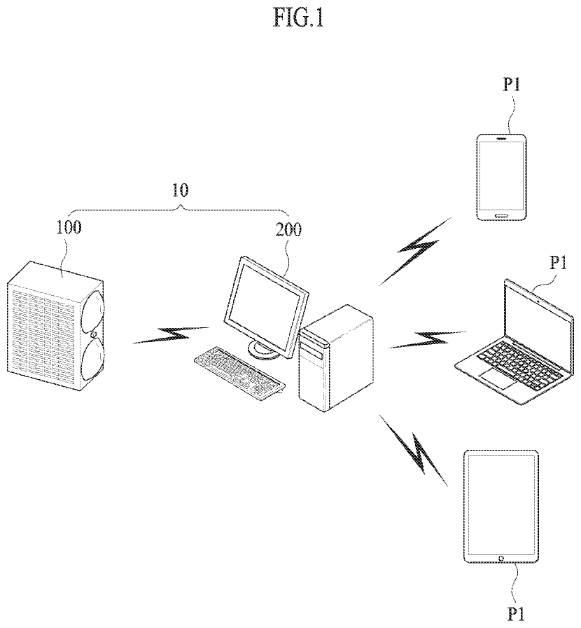

FIG. 1 is a schematic view for generally describing a dangerous article detection apparatus according to one embodiment of the present invention.

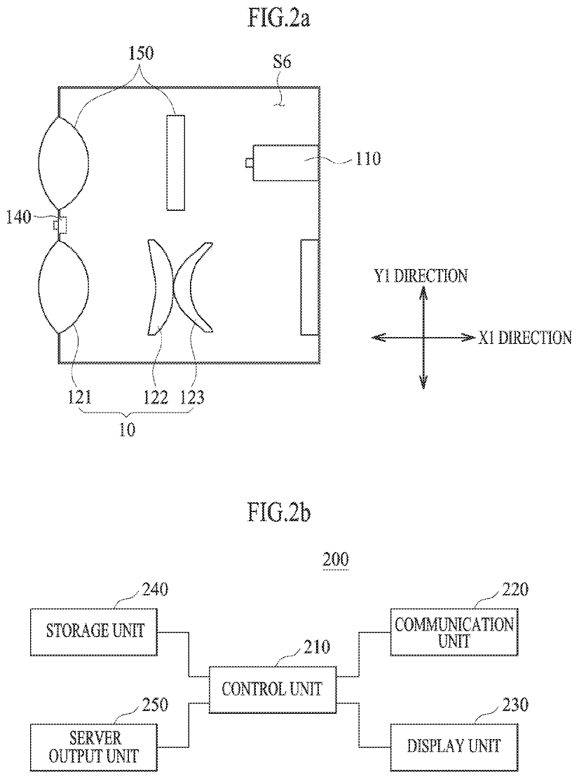

FIGS. 2A and 2B are a schematic view and a block diagram for describing an inspection module and a server constituting the dangerous article detection apparatus according to one embodiment of the present invention.

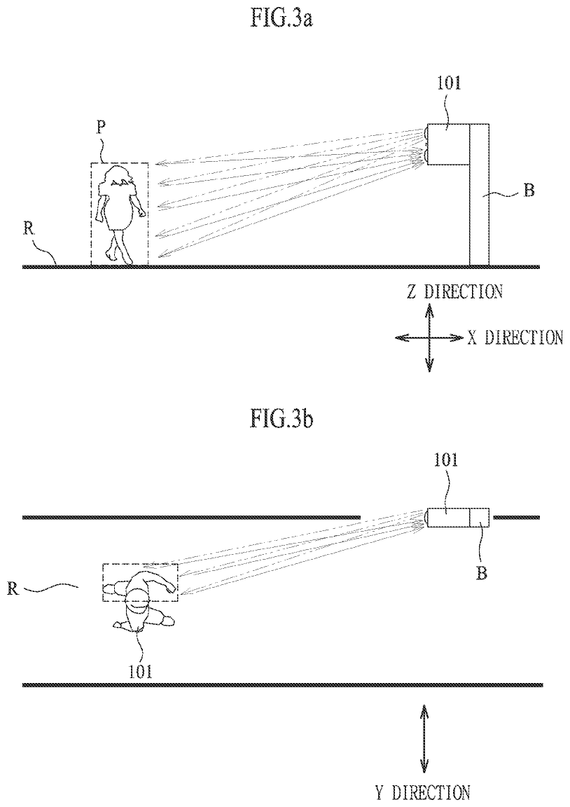

FIGS. 3A and 3B are a front view and a plan view for describing a state in which the dangerous article detection apparatus according to one embodiment of the present invention inspects an object to be inspected moving on an inspection path.

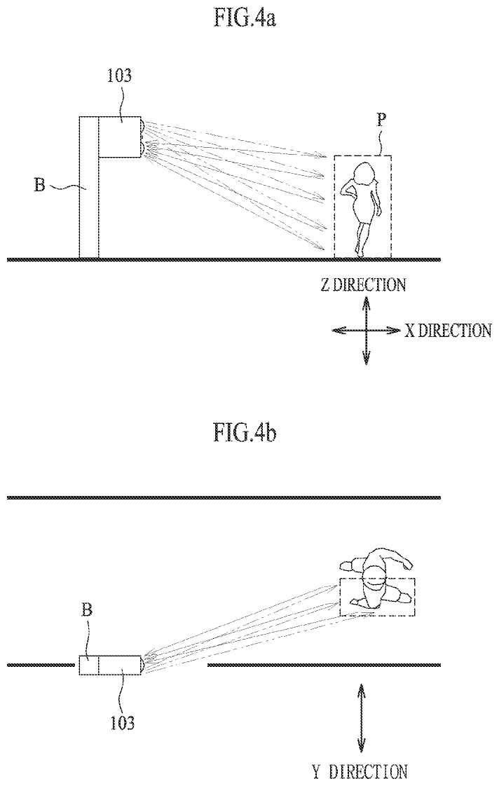

FIGS. 4A and 4B are a front view and a plan view for describing a state in which the dangerous article detection apparatus according to one embodiment of the present invention inspects the object to be inspected moving on the inspection path.

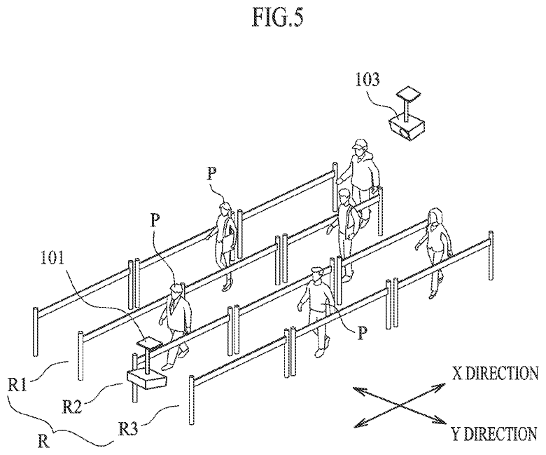

FIG. 5 is a schematic view for describing a state in which the dangerous article detection apparatus according to one embodiment of the present invention inspects a plurality of objects to be inspected moving on an inspection path.

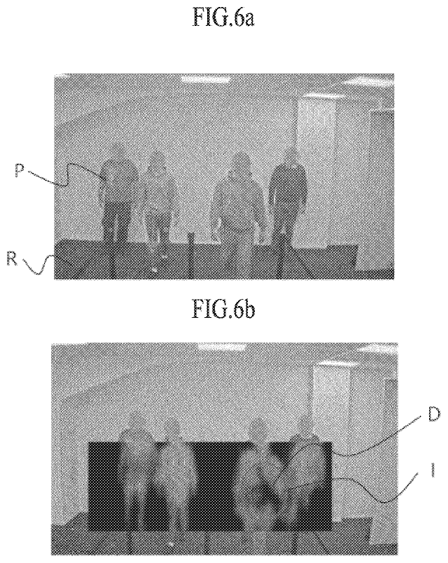

FIGS. 6A and 6B are photographs obtained by testing a hidden dangerous article detection by inspecting a plurality of objects to be inspected moving on an inspection path by the dangerous article detection apparatus according to one embodiment of the present invention.

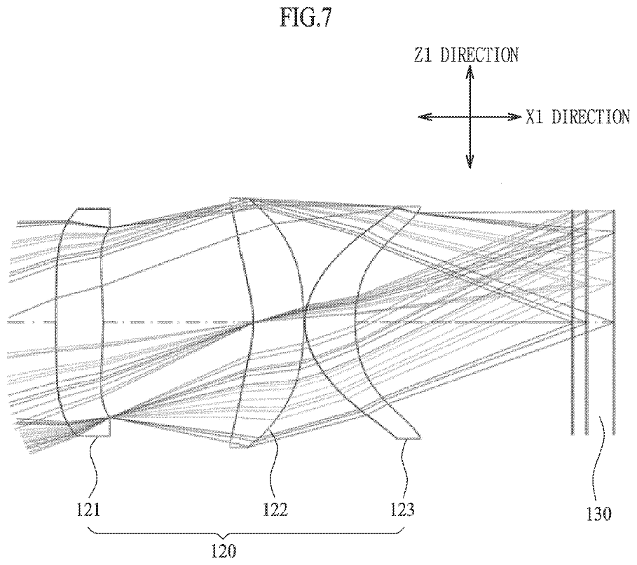

FIG. 7 is a front view for describing a lens unit that is a component of the dangerous article detection apparatus according to one embodiment of the present invention.

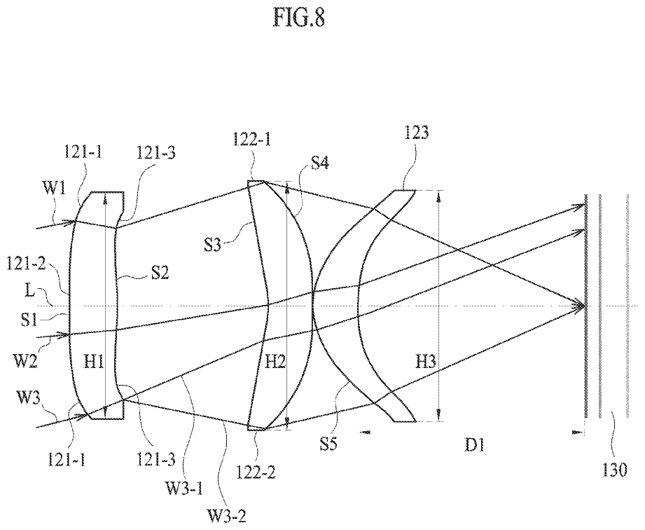

FIG. 8 is a front view for describing the lens unit that is a component of the dangerous article detection apparatus according to one embodiment of the present invention.

Parts irrelevant to the technical spirit of the present invention or can be easily derived from those skilled in the art are simplified or omitted in the accompanying drawings in order to clearly describe the technical spirit of the present invention.

Throughout the specification, when it is said that a part is “connected” to another part, this includes not only a “directly connected” case but also an “electrically connected” case while another element is arranged between them. In addition, when a part is said to “include” a certain component, it means that the part does not exclude other components, but may further include other components, unless specifically stated otherwise, and it should be understood that one or more other features or numbers, steps, operations, components, parts or existence of the combinations thereof, or possibility of addition is not excluded in advance.

In the present specification, the term, “unit” includes a unit realized by hardware, a unit realized by software, and a unit realized by using both. In addition, one unit may be realized by using two or more pieces of hardware, and two or more units may be realized by one piece of hardware.

In the present specification, some of operations or functions which are described as being performed by a terminal or a device may also be performed by a server connected to the corresponding terminal or device instead. Likewise, some of the operations or functions described as being performed by the server may also be performed by a terminal or device connected to the server.

Hereinafter, a dangerous article detection apparatus 10 according to one embodiment of the present invention will be described in detail with reference to FIGS. 1 to 8.

When defining terms for directions first, as can be seen in FIG. 3, an X direction may refer to a first direction, a Y direction may refer to a second direction, and a Z direction may refer to a third direction.

Further, as can be seen in FIG. 2A, an X1 direction may refer to a length direction (a length direction of an inspection module 100) in an arrangement space S6 formed in the inspection module, and a Z1 direction may refer to a height direction (a height direction of the inspection module) in the arrangement space formed in the inspection module.

A terahertz (THz) wave is a type of electromagnetic wave present in a frequency band of 0.1 THz to 10 THz (wavelength λ=3 mm to 30 μm), and is an electromagnetic wave of a frequency band corresponding to a boundary region between a light wave (light), which is optically accessible, and a radio wave (millimeter wave), which is electronically accessible, on the entire electromagnetic wave spectrum.

The THz wave is harmless to the human body unlike an X-ray in that the THz wave has a relatively large wavelength length. In addition, the THz wave transmits all materials except metal and liquid and reacts with constituent molecules of the material, so that components may be easily analyzed by extracting a unique spectrum.

The dangerous article detection apparatus 10 according to one embodiment of the present invention applies electromagnetic waves that are millimeter waves or THz waves to an inspection path R through which an object P to be inspected moves, receives electromagnetic waves reflected from the object P to be inspected, images the received electromagnetic waves, and detects a dangerous article D hidden by the object to be inspected.

As an example, the object P to be inspected may be a person, and the dangerous article detection apparatus 10 applies electromagnetic waves to the body of the person, and detects the dangerous article D such as pistols, knives, and narcotics hidden in the body part such as the groin and the armpit through electromagnetic waves reflected from the body of the person.

As another example, the object P to be inspected may be baggage such as a carrier, and in this case, the inspection path R may be a baggage moving device.

As an example, the dangerous article detection apparatus 10 may be installed in a place where many people are gathered, such as airport, harbor, railway, subway, public office, a large mart, school, religious facility, and athletic facility, and thus, by detecting dangerous articles, large-scale accidents such as terrorism can be prevented in advance.

As can be seen in FIGS. 3 and 4, the inspection module 100 constituting the dangerous article detection apparatus 10 may be installed on an installation stand B at a predetermined position of the inspection path R, or attached to and installed on a ceiling as can be seen in FIG. 5, and thus may be installed to be spaced apart from a bottom surface of the inspection path R by a predetermined distance in the third direction.

The predetermined distance is, for example, 3 m, and accordingly, the inspection module 100 can apply electromagnetic waves from a relatively upper side with respect to the object P to be inspected moving through the inspection path R on the basis of the third direction, so that the electromagnetic waves can be applied to the entire object P to be inspected on the inspection path R.

Thereafter, the inspection module 100 receives electromagnetic waves reflected from the object P to be inspected and thus generates image data for the object P to be inspected.

When describing this in more detail, as can be seen in FIG. 2A, the inspection module 100 may form the internal space S6, an output unit 110 disposed in the internal space S6 outputs electromagnetic waves that are millimeter waves or THz waves, and the output electromagnetic waves pass through an exit lens 150, thereby applying the electromagnetic waves to a person that is the object P to be inspected positionally moving in the first direction on the inspection path R.

The exit lens 150 may be, for example, a lens configured to refract the electromagnetic waves that are output from the output unit 110 so as to be applied in parallel in one direction.

The electromagnetic waves that have passed through the exit lens 150 are irradiated to the person that is the object P to be inspected, and the electromagnetic waves reflected from the object P to be inspected are focused by a lens unit 120 disposed in the internal space S6 of the inspection module 100 and then moved to an image generation unit 130.

The image generation unit 130 may be, for example, a millimeter wave camera or a THz wave camera, and receives the reflected electromagnetic waves to generate image data through an image signal processing board mounted therein.

In addition, the object P to be inspected may include a camera unit 140 disposed in the internal space S6, and a real image of the object P to be inspected may be generated through the camera unit 140.

The image data may be imaged using a difference between reflectance at which the electromagnetic waves applied to the object P to be inspected are not absorbed and reflected by the dangerous article D made of a metal material or a material other than the skin and reflectance at which the electromagnetic wave applied to the object P to be inspected is partially absorbed and partially reflected by the skin of a person that is the object P to be inspected, and generated through the image signal processing board mounted in the image generation unit 130.

The image generated by the camera unit 140 and the image data generated by the image generation unit 130 are transmitted to a server 200 constituting the dangerous article detection apparatus and output through a display unit 330 of the server 200.

The server 200 may be, for example, a computer.

The server 200 may include a communication unit 220, and the communication unit 220 receives the real image of the object P to be inspected generated by the camera unit 140 and the image data generated by the image generation unit 130.

A control unit 210 constituting the server 200 controls the image and the image data to be outputted to a display unit 230 such as a monitor.

As an example, a storage unit 240 constituting the server 200 may store reference data, which is image data corresponding to a plurality of dangerous articles.

Here, the reference data may refer to image data for various types of dangerous articles.

For example, the reference data may refer to image data for pistols having different types and models, and may refer to image data for knives having different types and models.

Accordingly, the control unit 210 determines a matching rate with the dangerous article D output from the image data on the basis of the reference data, and determines that the dangerous article D exists inside the object P to be inspected when the matching rate is greater than or equal to a predetermined range.

Accordingly, as can be seen in FIG. 1, when the dangerous article D is detected from the image data on the basis of the stored reference data, the control unit 210 controls the communication unit 220 to send a notification notifying that the dangerous article D hidden by the object P to be inspected is detected to an administrator terminal P1.

When the dangerous article D is detected from the image data on the basis of the stored reference data, as can be seen in FIG. 6B, the control unit 210 controls the display unit 230 to map the dangerous article D in the image with an icon I corresponding to the dangerous article and display the image.

Meanwhile, the server 200 may further include a server output unit 250 configured to output a voice notification, and when the dangerous article D is detected from the image data on the basis of the stored reference data, the control unit 210 controls the server output unit 250 to output an alarm sound notifying that the dangerous article D is detected.

However, although the image data is described as being generated by the image generation unit 130, of course, the image data may be generated through an image signal processing board mounted in the server 300 by transmitting the electromagnetic waves reflected from the object P to be inspected to the server 300.

In this case, the server 200 may directly detect the dangerous article D hidden by the object P to be inspected through an artificial intelligence (AI)-based dangerous article search algorithm controlled by the control unit 210.

The AI-based dangerous article search algorithm may generate image data through electromagnetic waves, and specify and distinguish a position of the dangerous article D from the image data.

In addition, the AI-based dangerous article search algorithm learns an expression model of the image data, and thus may distinguish abnormal data out of a general distribution, thereby more accurately detecting the dangerous article D.

In addition, when a result is derived that the dangerous article D is detected from the image data, the AI-based dangerous article search algorithm may add and output the basis for deriving the result in the form of an image or language that can be understood by a person, and when the dangerous article D is detected, the AI-based dangerous article search algorithm may perform automatic labeling for each dangerous article D.

Furthermore, an image data augmentation technique for learning may be applied for the AI-based dangerous article search algorithm, and accordingly, when the dangerous article D is detected, flipping, random array, or the like may be performed on the image of the dangerous article.

Meanwhile, the inspection module 100 may further include a first inspection module 101 configured to apply the electromagnetic waves to a front surface and one side surface of the object P to be inspected on the inspection path R, and a second inspection module 103 configured to apply the electromagnetic waves to a rear surface and the other side surface of the object P to be inspected on the inspection path R.

Each of the first inspection module 101 and the second inspection module 103 may include the output unit 110, the lens unit 120, the image generation unit 130, and the camera unit 140.

As can be seen in FIG. 3, the first inspection module 101 is installed such that the electromagnetic waves are applied to the front surface and one side surface of the object P to be inspected positionally moving on the inspection path R, and as can be seen in FIG. 4, the second inspection module 103 is installed such that the electromagnetic waves are applied to the rear surface and the other side surface of the object P to be inspected positionally moving on the inspection path R.

When describing this in more detail, the first inspection module 101 is installed to be spaced apart from the second inspection module 103 by a predetermined distance in the first direction, and the object P to be inspected is guided to move to a position close to the first inspection module 101 from a position close to the second inspection module 103 in the first direction.

Accordingly, as can be seen in FIGS. 3A and 4A, in the object P to be inspected that positionally moves in the first direction on the inspection path R, the front surface of the object P to be inspected is inspected by the first inspection module 101, and the rear surface of the object P to be inspected is inspected by the second inspection module 103.

In addition, the first inspection module 101 may be installed to be spaced apart from the second inspection module 103 by a predetermined distance in the second direction (Y direction) perpendicular to the first direction (X direction).

And accordingly, as can be seen in FIGS. 3B and 4B, in the object P to be inspected that positionally moves in the first direction on the inspection path R, one side surface (part including a person's left arm) of the object P to be inspected is inspected by the first inspection module 101, and the other side surface (part including a person's right arm) of the object P to be inspected is inspected by the second inspection module 103.

That is, since the first inspection module 101 is installed to be spaced a predetermined distance from the second inspection module 103 in the first direction and the second direction on the inspection path R, all of the front, rear, left, and right surfaces of the object P to be inspected are inspected by the first inspection module 101 and the second inspection module 103.

In addition, since the first inspection module 101 is installed to be spaced a predetermined distance from the second inspection module 103 in the first direction and the second direction on the inspection path R, interference between electromagnetic waves output from the first inspection module 101 and electromagnetic waves output from the second inspection module 103 may be prevented, and interference between electromagnetic waves (waves reflected by the object to be inspected) focused on the first inspection module 101 and electromagnetic waves (waves reflected by the object to be inspected) focused on the second inspection module 103 may be prevented.

Accordingly, each of the first inspection module 101 and the second inspection module 103 generates image data more accurately, and accordingly, the dangerous article detection apparatus 10 may detect the dangerous article D hidden in the object P to be inspected more carefully through the arrangement of the first inspection module 101 and the second inspection module 103 on the inspection path R.

Furthermore, since the first inspection module 101 is installed to be spaced apart from the second inspection module 103 on the inspection path R by a predetermined distance in the first and second directions, as can be seen in FIG. 5, the dangerous article detection apparatus 10 may perform searches for a dangerous article hidden inside the body for a plurality of objects P to be inspected.

Currently, a metal detector or an image detector used in airports and the like inspects an inside of the body for each individual in a state in which the object P to be inspected is stopped.

On the other hand, as can be seen in FIG. 5, the dangerous article detection apparatus may perform inspection while the objects P to be inspected move on the inspection path R, and also simultaneously inspect the plurality of objects P to be inspected, so that inspection efficiency of the object P to be inspected may be further increased.

Meanwhile, the lens unit 120 constituting the inspection module 100 may further include a first lens unit 121 configured to receive electromagnetic waves reflected from the object to be inspected and refract a portion of the electromagnetic waves at a predetermined angle, a second lens unit 122 disposed to be spaced apart from the first lens unit 121 by a predetermined distance in the length direction (X1 direction) of the inspection module 100 and configured to allow the electromagnetic waves emitted from the first lens unit 121 to be incident and refracted at a predetermined angle, and a third lens unit 123 that is partially in contact with the second lens unit 122 and allows the electromagnetic waves emitted from the second lens unit 122 to be incident and focused on the image generation unit 130.

When describing this in more detail, as can be seen in FIG. 7, the lens unit 120 may include the first lens unit 121 on which electromagnetic waves reflected from the object P to be inspected are initially incident, the second lens unit 122 on which electromagnetic waves emitted from the first lens unit 121 are incident, and the third lens unit 123 on which electromagnetic waves emitted from the second lens unit 122 are incident and which allows the electromagnetic waves to be fully focused on the image generation unit 130.

Here, since the inspection module 100 is disposed relatively higher than the object P to be inspected in the third direction, as can be seen in FIGS. 3A and 4A, the inspection module 100 applies electromagnetic waves (part marked in red) from an upper side of the object P to be inspected.

Accordingly, as can be seen in FIGS. 3A and 4B, electromagnetic waves (part marked in blue) reflected from the object P to be inspected are incident on the first lens unit 121 while forming a predetermined angle with a bottom surface of the inspection path R.

That is, as can be seen in FIG. 7, the electromagnetic waves incident on the first lens unit 121 are incident at a predetermined angle with respect to the X1 direction, which is the length direction of the inspection module.

Accordingly, in the first lens unit 121, a round portion 121-1 having a partially convex portion is formed on a first incident surface S1 to allow all the electromagnetic waves incident on the first lens unit 121 to be focused on the image generation unit 130 so that the image generation unit 130 generates more accurate image data.

Specifically, as can be seen in FIG. 8, the round portion 121-1 may be formed on one side and the other side of the first lens unit 121 in the height direction (Z1 direction), which is a direction perpendicular to the length direction of the inspection module 100.

Accordingly, as can be seen in FIG. 8, electromagnetic waves W1 and W3 incident on the round portions 121-1 are refracted at a predetermined angle by the round portions 121-1.

Accordingly, even when the electromagnetic waves W1 and W3 incident on the round portions 121-1 are emitted through a first exit surface S2, the electromagnetic waves W1 and W3 are fully incident on the second lens unit 122 instead of being incident and dispersed on the second lens unit 122.

In addition, the first lens unit 121 may further include a parallel portion 121-2 connected to the round portion 121-1 on the first incident surface S1 and formed to be parallel to the height direction of the inspection module 100.

Accordingly, an electromagnetic wave W2 incident on the parallel portion 121-2 has minimal refraction due to a medium difference between air and the lens (formed of glass or plastic).

Accordingly, the electromagnetic wave W2 incident on the parallel portion 121-2 may be fully incident on the second lens unit 122 even when the electromagnetic wave W2 is emitted through the exit surface S2 of the first lens unit 121.

Accordingly, since the first lens unit 121 includes the round portion 121-1 and the parallel portion 121-2, even when the first lens unit 121 and the second lens unit 122 are spaced apart from each other by a predetermined distance in the length direction of the inspection module 100, all the electromagnetic waves incident on the first lens unit 121 are fully applied to the second lens unit 122.

In addition, in the first lens unit 121, a round shape 121-3 corresponding to the round portion 121-1 is formed on the first exit surface S2, so that all the electromagnetic waves incident on the first lens unit 121 are fully applied to the second lens unit 122.

In other to realize this, a height H1 of the first lens unit 121 may be formed to be less than a height H2 of the second lens unit 122 in the height direction (Z1 direction) of the inspection module.

As can be seen in FIG. 8, the second lens unit 122 further includes a second incident surface S3 on which the electromagnetic waves emitted from the first lens unit 121 are incident and a second exit surface S4 through which the electromagnetic waves incident on the second lens unit 122 are emitted to the third lens unit 123.

As can be seen in FIG. 8, the second exit surface S4 may be formed in a convex shape so that the electromagnetic waves incident on the second lens unit 122 are refracted at a predetermined angle and focused on the third lens unit 123.

Accordingly, the electromagnetic waves W1 and W3 incident on the round portion 121-1 may be fully incident on the third lens unit 123 through the second exit surface S4.

In other to realize this, the height H2 of the second lens unit 122 may be formed to be greater than a height H3 of the third lens unit 123 in the height direction (Z1 direction) of the inspection module.

In addition, the second lens unit 122 and the third lens unit 123 may be partially in contact with each other at a portion including a virtual center line L in the length direction of the inspection module.

Accordingly, the electromagnetic wave W2 incident on the parallel portion 121-2 may be incident from the second lens unit 122 to the third lens unit 123 through a portion at which the second lens unit 122 is in contact with the third lens unit 123.

This is to minimize a refraction caused by a medium difference between air and the lens (formed of glass or plastic) by minimizing the contact of the electromagnetic wave W2 incident to the parallel portion 121-2 with the air.

In addition, the second incident surface S3 of the second lens unit 122 may be concavely formed.

Accordingly, when a portion W3-1 of the electromagnetic wave W3 incident relatively downward in the height direction of the inspection module among the electromagnetic waves incident on the round portion 121-1 is incident on the second incident surface S3, the portion W3-1 of the electromagnetic wave W3 may be refracted relatively upward by the second incident surface S3.

Accordingly, the portion W3-1 of the electromagnetic wave W3 incident relatively downward in the height direction of the inspection module may be moved through a path similar to that of the electromagnetic wave W2 incident on the parallel portion 121-2, and thus fully incident on the third lens unit 123 through the second exit surface S4.

An incident surface S5 of the third lens unit 123 may be formed in a convex shape, and accordingly, the electromagnetic waves passing through the first lens unit 121 and the second lens unit 122 are fully focused on the image generation unit 130.

That is, since the first lens unit 121 and the second lens unit 122 are disposed to be spaced apart from each other by a predetermined distance in the length direction, when the electromagnetic waves passing through the first lens unit 121 are incident on the second lens unit 122, the electromagnetic waves are allowed to face both ends and a center portion of the second lens unit 122 in the height direction.

In addition, since the second lens unit 122 and the third lens unit 123 are disposed to be partially in contact with each other, the electromagnetic waves passing through the second lens unit 122 are incident on the entire third lens unit 123, and as a result, the image generation unit 130 receives the entire electromagnetic waves collected in the first lens unit 121.

Accordingly, the image generation unit 130 receives the electromagnetic waves collected in the first lens unit 121 more efficiently, thereby more accurately generating the image data.

Accordingly, the dangerous article detection apparatus 10 may more accurately detect the dangerous article hidden by the object P to be inspected on the inspection path R.

While the present invention has been described with reference to the embodiments thereof, it should be understood that the present invention is not limited thereto, and those skilled in the art to which the invention pertains may make modifications and variations thereto, and such modifications or variations are within the scope of the appended claims.

1. A dangerous article detection apparatus configured to detect a dangerous article hidden by an object to be inspected by irradiating an electromagnetic wave, which is a millimeter wave or a terahertz wave, to an inspection path through which the object to be inspected moves, the dangerous article detection apparatus comprising:
an inspection module configured to apply the electromagnetic wave to the object to be inspected moving along the inspection path, receive an electromagnetic wave reflected from the object to be inspected, and generate image data on the basis of the electromagnetic waves; and
a server configured to display the dangerous article hidden by the object to be inspected on the basis of the image data received from the inspection module,
wherein the inspection module includes:
a camera unit configured to generate an image of the object to be inspected;
an output unit configured to output the electromagnetic wave;
a lens unit configured to focus the electromagnetic wave reflected from the object to be inspected; and
an image generation unit configured to receive the electromagnetic wave focused by the lens unit and generate the image data on the basis of the electromagnetic wave.

2. The dangerous article detection apparatus of claim 1, wherein
the inspection module further includes:
a first inspection module configured to apply the electromagnetic wave to a front surface and one side surface of the object to be inspected on the inspection path; and
a second inspection module configured to apply the electromagnetic wave to a rear surface and the other side surface of the object to be inspected on the inspection path,
wherein the first inspection module and the second inspection module are disposed to be spaced apart from each other by a predetermined distance in a first direction and in a second direction perpendicular to the first direction on the inspection path.

3. The dangerous article detection apparatus of claim 2, wherein
the server further includes:
a communication unit configured to receive the image data from the image generation unit;
a display unit configured to output the received image data;
a storage unit in which reference data, which is data corresponding to a plurality of dangerous articles, is stored; and
a control unit configured to control the communication unit, the display unit, and the storage unit,
wherein, when the hidden dangerous article is detected from the received image data on the basis of the reference data, the control unit controls the display unit to output an icon corresponding to the hidden dangerous article from the image data and controls the communication unit to send a notification notifying that the hidden dangerous article is detected to an administrator terminal.

4. The dangerous article detection apparatus of claim 3, wherein
the lens unit further includes:
a first lens unit configured to receive the electromagnetic wave reflected from the object to be inspected and refract a portion of the electromagnetic wave at a predetermined angle;
a second lens unit disposed to be spaced apart from the first lens unit by a predetermined distance in a length direction of the inspection module and configured to allow the electromagnetic wave emitted from the first lens unit to be incident and refracted at a predetermined angle; and
a third lens unit that is partially in contact with the second lens unit and allows the electromagnetic wave emitted from the second lens unit to be incident and focused on the image generation unit.

5. The dangerous article detection apparatus of claim 4, wherein
the first lens unit further includes a first incident surface on which the electromagnetic wave reflected from the object to be inspected is incident, and a first exit surface through which the incident electromagnetic wave is emitted,
wherein the first incident surface further includes a round portion having one side and the other side, each of which has a convex shape in a height direction of the inspection module perpendicular to the length direction of the inspection module, and a parallel portion extending from the round portion and parallel to the height direction, and
the first exit surface has a shape corresponding to a first incident surface.

6. The dangerous article detection apparatus of claim 5, wherein
the first lens unit is formed shorter than a length of the second lens unit in the height direction, and
the second lens unit further includes a second incident surface on which the electromagnetic wave emitted from the first exit surface is incident, and a second exit surface through which the incident electromagnetic wave is emitted,
wherein the second incident surface has a concave shape, and
the second exit surface has a convex shape.

7. The dangerous article detection apparatus of claim 6, wherein
the second lens unit is formed longer than a length of the third lens unit in the height direction, and
the third lens unit further includes a third incident surface on which the electromagnetic wave emitted from the second exit surface is incident,
wherein the third incident surface has a convex shape.
